(19) United States
(12) Patent Application Publication
(10) Pub. No.: US 2015/0077548 A1
(43) Pub. Date: Mar. 19, 2015

(54) MOBILE DEVICE INTERMEDIARY FOR CONTENT ANALYSIS

(71) Applicant: AT&T Mobility II LLC, Atlanta, GA (US)

(72) Inventors: Sheldon Kent Meredith, Marietta, GA (US); Jeremy Fix, Acworth, GA (US); Mario Kosseifi, Roswell, GA (US)

(73) Assignee: AT&T MOBILITY II LLC, Atlanta, GA (US)

(21) Appl. No.: 14/026,910

(22) Filed: Sep. 13, 2013

(51) Int. Cl. H04N 7/18

(52) U.S. Cl. CPC H04N 7/183
USPC 348/143

(57) ABSTRACT

A mobile device intermediary is disclosed. A mobile device intermediary can access content and perform content analysis based on criterion received from a remotely located device. A mobile device intermediary can comprise a consumer electronic mobile device. The mobile device intermediary can facilitate access to a subset of the content by the remotely located device. Distributed analysis of content by a plurality of mobile device intermediaries can facilitate analysis of large volumes of content without needing to transmit the content to a central analysis device. This can reduce the amount of data transmitted over a network. Similarly, this can reduce computational load at the remotely located device. Additionally, a greater level of privacy is accomplished by returning relevant content rather than submitting all content for analysis. A mobile device intermediary can avoid alerting at the mobile device to preserve query privacy and content security.

### TECHNICAL FIELD

The disclosed subject matter relates to content analysis.

### BACKGROUND

By way of brief background, content analysis can facilitate identification of content containing target characteristics. As an example, a police cruiser can employ a camera system and dedicated software running on a co-installed laptop computer to capture license plate information from vehicles as the police cruiser is driven. As another example, image content or audio content can be analyzed on a computer at a law enforcement facility to locate persons of interest, missing persons, vehicles of interest, gunshot sounds, or even terrorist activities. Even some mobile devices can analyze content to perform activities like facial recognition, license plate recognition, etc., and report the results on the mobile device, e.g., wearable mobile devices that perform facial recognition.

### BRIEF DESCRIPTION OF DRAWINGS

FIG. 1 is an illustration of a system that facilitates employing a mobile device as an intermediary for content analysis in accordance with aspects of the subject disclosure.

FIG. 2 is a depiction of a system that facilitates employing a consumer electronic mobile device as an intermediary for content analysis in accordance with aspects of the subject disclosure.

FIG. 3 illustrates a system that facilitates employing a smartphone device as an intermediary for content analysis in accordance with aspects of the subject disclosure.

FIG. 4 illustrates a system that facilitates employing a smartphone device as an intermediary for content analysis from a surveillance system in accordance with aspects of the subject disclosure.

FIG. 5 illustrates an exemplary system that employs a mobile device as an intermediary for content analysis between a remote query device and a surveillance system via a wireless carrier network in accordance with aspects of the subject disclosure.

FIG. 6 illustrates a method facilitating employing a mobile device as an intermediary for content analysis in accordance with aspects of the subject disclosure.

FIG. 7 illustrates a method facilitating employing a mobile device as an intermediary for content analysis of content from a content device other than the mobile device in accordance with aspects of the subject disclosure.

FIG. 8 illustrates a method facilitating employing a smartphone device as an intermediary for content analysis between a remote query device and a surveillance system device via a radio access network in accordance with aspects of the subject disclosure.

FIG. 9 depicts a schematic block diagram of a computing environment with which the disclosed subject matter can interact.

FIG. 10 illustrates a block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

Conventional content analysis is generally performed on a device that is also employed in notification of the analysis results. Further, conventional content analysis generally does not employ a mobile device as an intermediary device in content analysis, more especially telecommunications based mobile devices, e.g., smartphones, cellular phones, etc. As an example, some parking enforcement systems include cameras and vehicle mounted computers that can capture and track vehicular criteria, such as license plate numbers, to alert a parking enforcement officer of a parking offence, such as being parked overtime in a metered parking area. Further, some of these types of systems can also search for specific vehicular criteria, such as license plates associated with stolen vehicles. The specific vehicular criteria searches are generally based on target criteria transferred to the vehicle mounted computer at the start of a shift, for example. The vehicle-mounted computer can then compare the target criteria against real time image analysis, for example, to alert an officer via the vehicle-mounted computer of an identified license plate matching an earlier downloaded plate number associated with a stolen vehicle.

However, the analysis of content is typically performed on the same device that alerts the user to the presence of target characteristics in the content, e.g., the police cruiser laptop alerts the police officer via the laptop, the computer at the law enforcement facility informs the analyst on the same computer, and the mobile device alerts the user on the mobile device. Conventional systems also do not typically employ a mobile device as an intermediary between a content source device and a reporting device, e.g., they do not generally use a mobile device to receive an analysis parameter, access the content, analyze the content and facilitate access to a subset of the content that is pertinent to the analysis parameter to another device other than the mobile device.

In comparison to conventional systems, a mobile device intermediary (MDI) in accord with the instant specification, such as a consumer electronic mobile device, can access stored images, voicemail, video, etc., and perform content analysis for target characteristics. In contrast, conventional content analysis systems generally do not leverage consumer electronics to perform a distributed analysis of content from a variety of content sources. Further, a MDI, for example, a consumer electronic mobile device, can base analysis on criteria received from a remotely located device and facilitate access to the results by the remotely located device. This can allow for distributed analysis of a large set of content by numerous MDIs to search through large volumes of content without needing to transmit the full set of content to a central analysis device. This can reduce the amount of data transmitted over a network in comparison to first transmitting all of the content to the remotely located device and then performing the analysis on the remotely located device. As an example, where a terrorist act, such as the Boston Marathon bombing occurs, search criteria could be sent out from a remote law enforcement facility to mobile devices near the bombing location, such that the mobile devices could search content created near the time and location of the bombing for target characteristics, then, where pertinent content is identified, this content could be returned to the remotely located law enforcement facility. This example illustrates that merely a subset of the searched content can be returned to the remotely located law enforcement facility rather than transmitting all of the content from each mobile device to the analysis facility. Further, this example illustrates a lower level of privacy invasion as illustrated by only returning content to the law enforcement facility that is determined to be relevant rather than submitting all content for analysis at an analysis facility. Moreover, this example illustrates that a mobile device can be an intermediary device that does not alert an owner of the mobile device to the results of the analysis, thereby keeping law enforcement tactics within the control of the law enforcement agency, although the owner of the mobile device can be asked to consent to analysis of content before it occurs.

In an aspect, a mobile device intermediary for content analysis can receive content from devices other than the mobile device. These other devices can be located near to the mobile device. As an example, a mobile device intermediary can access content from a surveillance system device or security system device located in the same general region as the mobile device intermediary. This access can be by a wired connection or a wireless connection, such as accessing a security camera by a near-me area network, body area network, personal area network, local area network, or near field communication connection, e.g., infrared data association (IrDA), Wireless universal serial bus (USB), Bluetooth, Z-Wave, ZigBee, etc. Thus, in the example, a mobile device intermediary can employ a Bluetooth-type wireless connection to access a content data storage device of a surveillance system in a local corner grocery store to facilitate analysis of content stored on the surveillance system device. As another example, an automated teller machine (ATM) camera data store can be accessed by a mobile device intermediary to facilitate analysis of stored content. Other examples can include accessing a traffic camera, kiosk camera, parking meter camera, campus emergency phone audio data, etc. from nearby consumer electronic mobile devices, such as smartphones, tablet computers, consumer vehicle-integrated computers, etc. Still further, consumer digital cameras and consumer video cameras can be accessed for analysis of content either by a local wireless technology or by a tether cable, for example, the digital camera in use on a beach can be remotely queried by a government organization, such as NOAA, to determine a substantial drop in the tide level that might indicate an impending tsunami to facilitate more precise evacuations. Similarly, professionally captured content, such as by news crew cameras and microphones, can be accessed by a mobile device intermediary. Privacy techniques, such as aggregation of data, redaction, etc., can be further employed to protect the privacy of those associated with analyzed content. In an embodiment, MDIs can be implemented with or without device owner consent, such as, in a time of national or regional emergency a government order can be employed to direct content analysis where the benefit of the nation or region outweighs the privacy interests of individuals, for example, MDIs could have been employed in the Sep. 11, 2001 terrorist acts in New York to rapidly collect content related to the impact of the planes into the World Trade Center from local content stores, news content stores, surveillance systems in the area, etc., rather than the government having to put out requests for individuals to submit information individually.

This wide access to content by the nearly ubiquitous distribution of mobile devices, many with image/video/audio capture capability, such as smartphones and cellular phones, can allow for distributed analysis of content to return relevant content to a remotely located query device with a reduction in overall data transmission as compared to returning all content for centralized analysis. Further, analysis can be faster where many processors are each analyzing small sets of content as compared to forming a large content repository for analysis by a local device. Analysis criteria or search criteria can be received by a mobile device intermediary, e.g., by pushing out the criteria to participating MDIs, MDIs subscribing to a service, users directing a MDI event, etc., to facilitate analysis of content. In an aspect, this can support improved response to events such as Amber alerts, vehicle identification by characteristic, facial recognition of individuals by characteristic, recognition of clothing or accessories, crowd characteristics and behaviors (such as a thrown object, sound of breaking glass, gunfire flash or sound, etc.), license plate identifiers, sounds, weather events, etc. As an example, a university administrator can remotely employ a proctor's smartphone to access video content for the proctor's exam room to analyze the content for characteristic student head movements that can be indicative of potential cheating on the exam, such that images can be returned to the administrator's computer relative to content containing suspect head movements. As a further example, a parent can remotely employ a child's cell phone to access a playground surveillance system to perform analysis for audio content indicating bullying behavior such that related images are made accessible to the parent's remotely located laptop computer when potential bullying terms are heard at the playground. While numerous other examples are readily appreciated, not all such examples are herein presented for the sake of clarity and brevity, though all such examples are considered within the scope of the present disclosure.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages and novel features of the disclosed subject matter will become apparent from the following detailed description when considered in conjunction with the provided drawings.

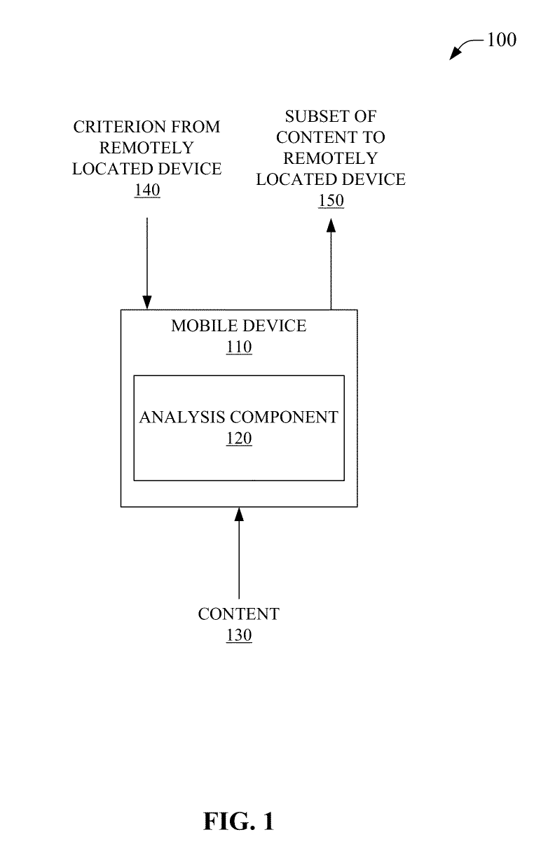

FIG. 1 is an illustration of a system 100, which facilitates employing a mobile device as an intermediary for content analysis in accordance with aspects of the subject disclosure. System 100 can include mobile device 110. Mobile device 110 can be a smartphone, tablet computer, laptop computer, or any other type of mobile device. In an aspect, mobile device 110 can be a consumer electronic device, e.g., a mobile device intended for consumer use as compared to use by an agency, government, or other mission specific group of users. As an example, mobile device 110 can be a soccer mom's smartphone as compared to a police department smartphone issued to an officer for use on patrol. As a further example, mobile device 110 can be a vehicle integrated computer for a vehicle belonging to and purchased by a bank teller as compared to a vehicle-mounted laptop in a parking enforcement vehicle.

Mobile device 110 can comprise analysis component 120. Analysis component 120 can analyze content to determine an occurrence of a characteristic, property, attribute, or feature of the content. Content can comprise an image, a video frame, a sound or other type of audio content, a smell or other olfactory content, etc. In an aspect, content can further comprise information related to an image, video, audio, etc., such as location information, time, date, temperature, direction, acceleration, color saturation, motion, etc. As such, analysis component 120 can analyze content to determine, for example, a facial feature, a vehicle type, a vehicle make, a vehicle model, a height, a gender, an age, an article of clothing, a clothing accessory, eye color, ethnicity, motion, a flash, a sharp sound/report/bang, a sound of breaking glass, a weather characteristic, a pressure wave front, smoke, mist, etc., occurring in the content. In an aspect, analysis component 120 can determine a subset of the content based on the analysis of the content, e.g., determining a subset of content comprising a male, a truck, a firearm report, a thrown bottle, etc. It will be noted that analysis of content is well-known and only tangentially related to the broader disclosure presented herein and, as such, further discussion of content analysis is not presented for the sake of clarity and brevity, although all such content analysis is considered within the scope of the present disclosure.

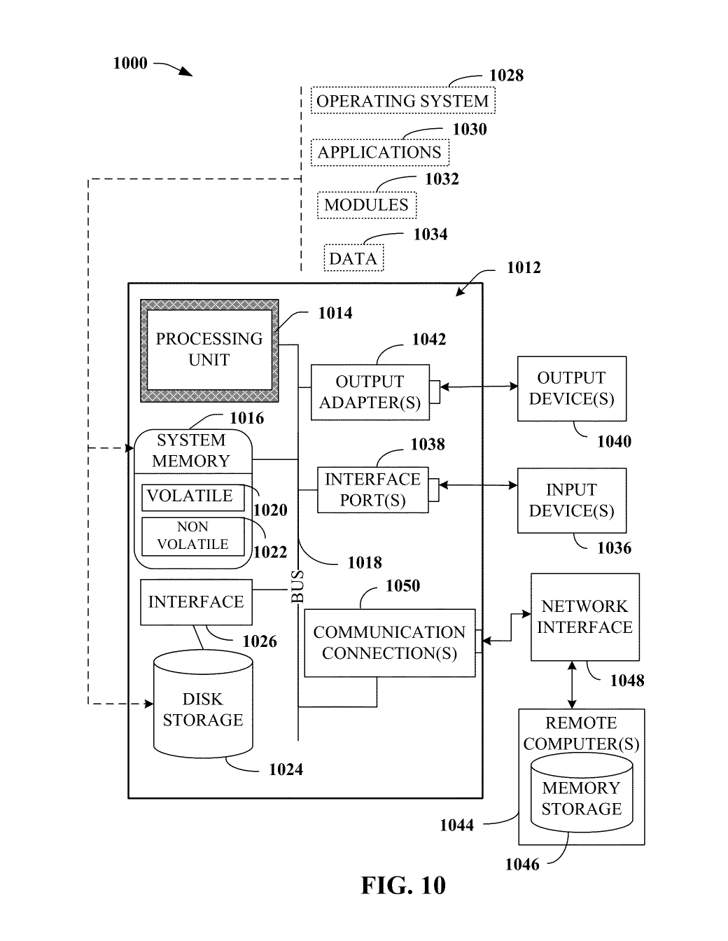

Mobile device 110 can receive content 130 to facilitate analysis of content 130 via analysis component 120. As disclosed herein, content 130 can comprise an image, a video frame, a sound or other type of audio content, a smell or other olfactory content, etc. In an aspect, content can further comprise information related to an image, video, audio, etc., such as location information, time, date, temperature, direction, acceleration, color saturation, motion, etc. In an aspect, content 130 can be stored on mobile device 110, e.g., stored in a memory of mobile device 110 as disclosed herein, such as the disclosure related to FIG. 10. In a further aspect, content 130 can be received from a device associated with mobile device 110, e.g., from a cloud based storage account, etc. Moreover, in an aspect, content 130 can be received from a local device, e.g., from a camera, video recorder, microphone, or other sensor, etc., in the general proximity of mobile device 110, for example, from an ATM camera located a few feet from mobile device 110, a Bluetooth-type connected headset microphone, a wearable device such as a Google Glass-type device, etc. Still further, in an aspect, content 130 can be received from a content storage device located near mobile device 130, for example, from a tethered digital camera, from a wirelessly connected traffic camera, from a bodega store security system storage device, etc. Mobile device 110 can negotiate access to content 130 to facilitate analysis of content 130 (not illustrated). Access can be based on access protocols associated with a remotely located device querying content 130 via a MDI comprising mobile device 110. As an example, where a government agency queries an ATM camera content by way of mobile device 110 belonging to a nanny standing near the ATM, access to the ATM content can be allowed based on a protocol associated with the government agency in contrast to the nanny not being allowed access to the ATM content. This aspect can allow remotely located query devices having the right permissions to access content that would not generally be accessible by an owner of a consumer electronic device.

Mobile device 110 can receive criterion from remotely located device (criterion) 140. Criterion 140 can be received by mobile device 110 through a wired connection or a wireless connection. Where criterion 140 is received by a wireless connection, this connection can comprise cellular signaling, Wi-Fi signaling, Bluetooth-type signaling, etc. In an aspect, mobile device 110 can be coupled to a radio access network (RAN) operated by a wireless network provider such that criterion 140 can be received via the RAN. As an example, criterion 140 can be received from a NodeB, a femtocell, etc. Criterion 140 can be employed in analysis of content to facilitate identifying and/or determining a subset of relevant content via analysis component 120.

Mobile device can facilitate access to subset of content to remotely located device (subset of content) 150. Subset of content 150 can comprise relevant content determined from analysis of content 130 by analysis component 120 based on criterion 140. Of note, subset of content 150 can be none, some, or all of content 130. In an embodiment, subset of content 150 can be made accessible to the same remotely located device that provided criterion 140. As such, mobile device 110 acts as a MDI for analysis of content 130 based on criterion 140 and returning subset of content 150 to a remotely located device. As such, analysis of content can be offloaded from the remotely located device which can both reduce computation performed by the remotely located device where analysis is performed at analysis component 120 rather than at the remotely located device and can also reduce the amount of data that can be communicated to the remotely located device because only a subset of content 130, rather than content 130, can be communicated back to the remotely located device.

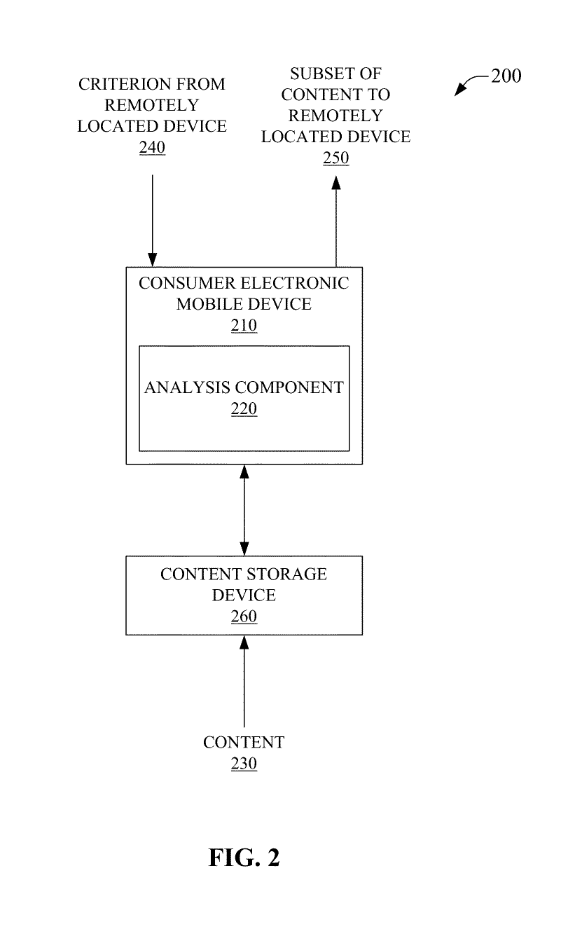

FIG. 2 is a depiction of a system 200 that can facilitate employing a consumer electronic mobile device as an intermediary for content analysis in accordance with aspects of the subject disclosure. System 200 can include consumer electronic mobile device 210. Consumer electronic mobile device 210 can be a smartphone, tablet computer, laptop computer, or any other type of mobile device. In an aspect, consumer electronic mobile device 210 can be a consumer electronic device, e.g., a mobile device intended for consumer use as compared to use by an agency, government, or other mission specific group of users. As an example, consumer electronic mobile device 210 can be a secretary's cellphone as compared to a vehicle-integrated computer in a law enforcement vehicle.

Consumer electronic mobile device 210 can comprise analysis component 220. Analysis component 220 can analyze content to determine an occurrence of a characteristic, property, attribute, or feature of the content. In an aspect, analysis component 220 can determine a subset of the content based on the analysis of the content. Content can be received via content storage device 260. Content storage device 260 can comprise a memory to store content 230. Content 230 can be generated from an image sensor, a video sensor, a microphone, a temperature sensor, a motion sensor, or nearly any other sensor. Content storage device 260 can be, for example, a storage device in a surveillance system, an ATM, a traffic camera, a kiosk camera, a parking meter camera, a gunshot tracking microphone array, a news agency camera, etc.

Consumer electronic mobile device 210 can receive content 230 via content storage device 260 to facilitate analysis of content 230 by analysis component 220. Content 230 can comprise an image, a video frame, a sound or other type of audio content, a smell or other olfactory content, etc. In an aspect, content 230 can further comprise information related to an image, video, audio, etc., such as location information, time, date, temperature, direction, acceleration, color saturation, motion, etc. In an aspect, content 230 can be received from content storage device 260 located near mobile device 230, for example, from a tethered digital camera, from a wirelessly connected traffic camera, from a hospital security system storage device, etc. Consumer electronic mobile device 210 can negotiate access to content 230 stored on content storage device 260 to facilitate analysis of content 230 (not illustrated). Access can be based on access protocols associated with a remotely located device querying content 230 via a MDI comprising consumer electronic mobile device 210. This aspect can allow remotely located query devices having the right permissions to access content on content storage device 260 that would not generally be accessible by an owner of consumer electronic mobile device 210.

Consumer electronic mobile device 210 can receive criterion from remotely located device (criterion) 240. Criterion 240 can be received by consumer electronic mobile device 210 through a wired connection or a wireless connection. Where criterion 240 is received by a wireless connection, this connection can comprise cellular signaling, Wi-Fi signaling, Bluetooth-type signaling, etc. In an aspect, consumer electronic mobile device 210 can be coupled to a RAN operated by a wireless network provider such that criterion 240 can be received via the RAN. As an example, criterion 240 can be received from a NodeB, a femtocell, etc. Criterion 240 can be employed in analysis of content to facilitate identifying and/or determining a subset of relevant content via analysis component 220.

Consumer electronic mobile device 210 can facilitate access to subset of content to remotely located device (subset of content) 250. Subset of content 250 can comprise relevant content determined from analysis of content 230 stored on content storage device 260 by analysis component 220 based on criterion 240. Of note, subset of content 250 can be none, some, or all of content 230. In an embodiment, subset of content 250 can be made accessible to the same remotely located device that provided criterion 240. As such, consumer electronic mobile device 210 can act as a MDI for analysis of content 230 based on criterion 240 and returning subset of content 250 to a remotely located device. As such, analysis of content can be offloaded from the remotely located device which can both reduce computation performed by the remotely located device where analysis is performed at analysis component 220 rather than at the remotely located device and can also reduce the amount of data that can be communicated to the remotely located device because only a subset of content 230, rather than content 230, can be communicated back to the remotely located device.

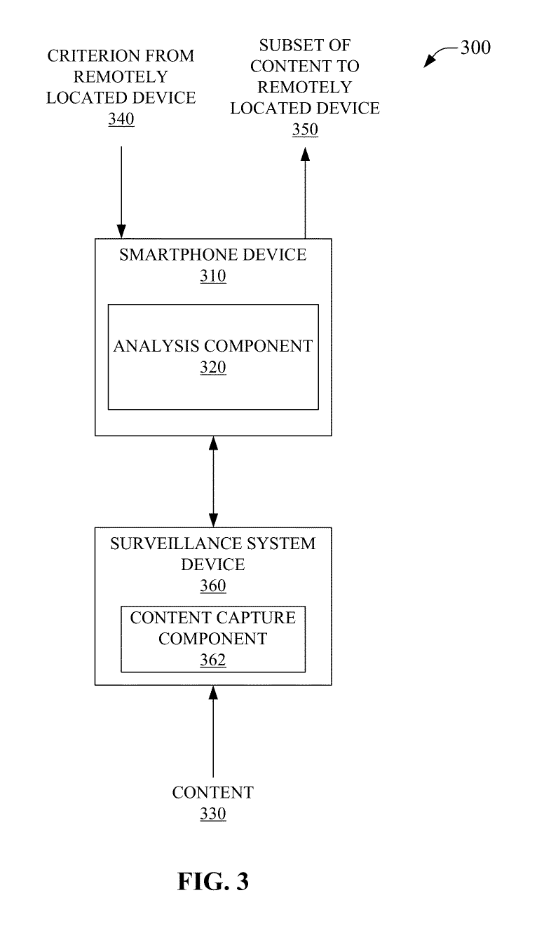

FIG. 3 illustrates a system 300 that facilitates employing a smartphone device as an intermediary for content analysis in accordance with aspects of the subject disclosure. System 300 can include smartphone device 310. In an aspect, smartphone device 310 can be a consumer electronic device, e.g., a mobile device intended for consumer use as compared to use by an agency, government, or other mission specific group of users. As an example, smartphone device 310 can be a child's smartphone as compared to a school issued teacher's smartphone with specific access to school related content sources.

Smartphone device 310 can comprise analysis component 320. Analysis component 320 can analyze content to determine an occurrence of a characteristic, property, attribute, or feature of the content. In an aspect, analysis component 320 can determine a subset of the content based on the analysis of the content. Content can be received via surveillance system device 360. Surveillance system device 360 can comprise a content capture component 362 that can receive content 330. In an aspect, surveillance system device 360 can further include a content storage component (not illustrated) to store content 330. Content 330 can be generated from an image sensor, a video sensor, a microphone, a temperature sensor, a motion sensor, or nearly any other sensor and be captured into surveillance system device 360 by content capture component 362. Surveillance system device 360 can be, for example, a grocery store surveillance system that can comprise an image capture component (content capture component 362) to capture images (content 330) from an image sensor (not illustrated) and store the images on a hard drive device (content store, not illustrated).

Smartphone device 310 can receive content 330 via surveillance system device 360 to facilitate analysis of content 330 by analysis component 320. Content 330 can comprise an image, a video frame, a sound or other type of audio content, a smell or other olfactory content, etc. In an aspect, content 330 can further comprise information related to an image, video, audio, etc., such as location information, time, date, temperature, direction, acceleration, color saturation, motion, etc. In an aspect, content 330 can be received from surveillance system device 360 located near mobile device 330, for example, from a digital video recorder of a bank surveillance system by way of a USB cable, from a wirelessly connected traffic camera, etc. Smartphone device 310 can negotiate access to content 330 on surveillance system device 360 to facilitate analysis of content 330 (not illustrated). Access can be based on access protocols associated with a remotely located device querying content 330 via a MDI comprising smartphone device 310. This aspect can allow remotely located query devices having the right permissions to access content from surveillance system device 360 that would not generally be accessible by an owner of smartphone device 310.

Smartphone device 310 can receive criterion from remotely located device (criterion) 340. Criterion 340 can be received by smartphone device 310 through a wired connection or a wireless connection. Where criterion 340 is received by a wireless connection, this connection can comprise cellular signaling, Wi-Fi signaling, Bluetooth-type signaling, etc. In an aspect, smartphone device 310 can be coupled to a RAN operated by a wireless network provider such that criterion 340 can be received via the RAN. As an example, criterion 340 can be received from a NodeB, a femtocell, etc. Criterion 340 can be employed in analysis of content to facilitate identifying and/or determining a subset of relevant content via analysis component 320.

Smartphone device 310 can facilitate access to subset of content to remotely located device (subset of content) 350. Subset of content 350 can comprise relevant content determined from analysis of content 330 from surveillance system device 360 by analysis component 320 based on criterion 340. Of note, subset of content 350 can be none, some, or all of content 330. In an embodiment, subset of content 350 can be made accessible to the same remotely located device that provided criterion 340. As such, smartphone device 310 can act as a MDI for analysis of content 330 based on criterion 340 and returning subset of content 350 to a remotely located device. As such, analysis of content can be offloaded from the remotely located device. This can reduce computation performed by the remotely located device because analysis is performed at analysis component 320 rather than at the remotely located device. Further, this can also reduce the amount of data that can be communicated to the remotely located device because only a subset of content 330, rather than content 330, can be communicated back to the remotely located device.

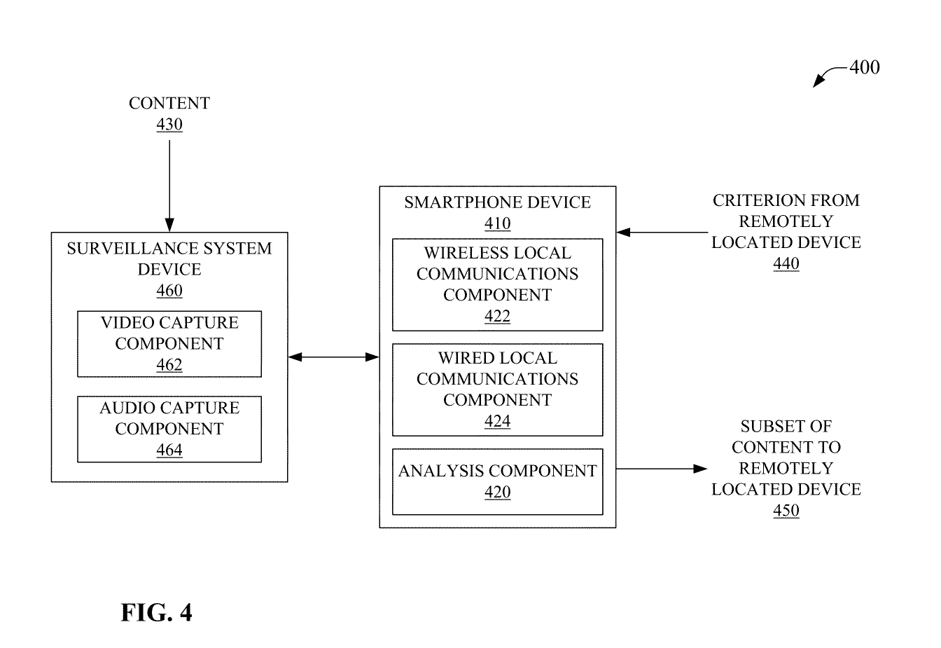

FIG. 4 illustrates a system 400 that facilitates employing a smartphone device as an intermediary for content analysis from a surveillance system in accordance with aspects of the subject disclosure. System 400 can include smartphone device 410. In an aspect, smartphone device 410 can be a consumer electronic device, e.g., a mobile device intended for consumer use as compared to use by an agency, government, or other mission specific group of users. Smartphone device 410 can comprise analysis component 420. Analysis component 420 can analyze content to determine an occurrence of a characteristic, property, attribute, or feature of the content. In an aspect, analysis component 420 can determine a subset of the content based on the analysis of the content.

Smartphone device 410 can further comprise wireless local communications component 422. Wireless local communications component 422 can facilitate smartphone device 410 communicating with other nearby devices, e.g., surveillance system device 460, etc., by way of a wireless connection to the nearby device. A nearby device can include a device that can be wirelessly connected to over Wi-Fi, e.g., IEEE 802.11a, b, g, n, etc., Bluetooth, ZigBee, etc. As such, a nearby device can include a device about 5000 meters away for an 802.11a connection in the 3.7 GHz frequency range, but will more typically be a device in about the 10's or 100's of meters, for example with an 802.11n connection at about 250 meters, and 802.11b connection at about 150 meters, a Bluetooth Class-1 connection at about 100 meters, a Bluetooth Class-2 connection at about 10 meters, etc.

Smartphone device 410 can also comprise a wired local communications component 424. Wired local communications component 424 can facilitate smartphone device 410 communicating with other nearby devices, e.g., surveillance system device 460, etc., by way of a wired connection to the nearby device. Wired connections can comprise USB cables, Firewire cables, serial port cables, parallel port cables, High-Definition Multimedia Interface (HDMI) cables, digital visual interface (DVI) cables, DisplayPort cables, Ethernet cables, etc.

Smartphone device 410 can be communicatively coupled to a nearby device, e.g., surveillance system device 460, etc., by way of wireless local communications component 422 or wired local communications component 424. Content can be received via surveillance system device 460. Surveillance system device 460 can comprise video capture component 462 that can receive visual content comprising content 430. Further, surveillance system device 460 can comprise audio capture component 464 that can receive audio content comprising content 430. In an aspect, surveillance system device 460 can further include a content storage component (not illustrated) to store content 430. Content 430 can be generated from an image sensor, a video sensor, a microphone, etc., and be captured into surveillance system device 460 by video capture component 462 and/or audio capture component 464. Surveillance system device 460 can be, for example, a traffic monitoring surveillance system that can comprise an image capture component (video capture component 462) to capture images (image content of content 430) from an image sensor (not illustrated) and store the images on a hard drive device (content store, not illustrated). As another example, surveillance system device 460 can be a gunshot monitoring surveillance system that can comprise an audio capture component (audio capture component 464) to capture gunshot sounds (audio content of content 430) from an audio sensor (not illustrated) and store the images on a hard drive device (content store, not illustrated).

Smartphone device 410 can receive content 430 via surveillance system device 460 to facilitate analysis of content 430 by analysis component 420. Content 430 can comprise an image, a video frame, a sound or other type of audio content, etc. In an aspect, content 430 can further comprise information related to an image, video, audio, etc., such as location information, time, date, temperature, direction, acceleration, color saturation, motion, etc. In an aspect, content 430 can be received from surveillance system device 460 located near mobile device 430. Smartphone device 410 can negotiate access to content 430 via surveillance system device 460 to facilitate analysis of content 430 (not illustrated). Access can be based on access protocols associated with a remotely located device querying content 430 via a MDI comprising smartphone device 410. This aspect can allow remotely located query devices having the right permissions to access content from surveillance system device 460 that would not generally be accessible by an owner of smartphone device 410.

Smartphone device 410 can receive criterion from remotely located device (criterion) 440. Criterion 440 can be received by smartphone device 410 through a wired connection or a wireless connection. Where criterion 440 is received by a wireless connection, this connection can comprise cellular signaling, Wi-Fi signaling, Bluetooth-type signaling, etc. In an aspect, smartphone device 410 can be coupled to a RAN operated by a wireless network provider such that criterion 440 can be received via the RAN. As an example, criterion 440 can be received from a NodeB, a femtocell, etc. Criterion 440 can be employed in analysis of content to facilitate identifying and/or determining a subset of relevant content via analysis component 420.

Smartphone device 410 can facilitate access to subset of content to remotely located device (subset of content) 450. Subset of content 450 can comprise relevant content determined from analysis of content 430 from surveillance system device 460 by analysis component 420 based on criterion 440. Of note, subset of content 450 can be none, some, or all of content 430. In an embodiment, subset of content 450 can be made accessible to the same remotely located device that provided criterion 440. As such, smartphone device 410 can act as a MDI for analysis of content 430 based on criterion 440 and returning subset of content 450 to a remotely located device. As such, analysis of content can be offloaded from the remotely located device. This can reduce computation performed by the remotely located device because analysis is performed at analysis component 420 rather than at the remotely located device. Further, this can also reduce the amount of data that can be communicated to the remotely located device because only a subset of content 430, rather than content 430, can be communicated back to the remotely located device.

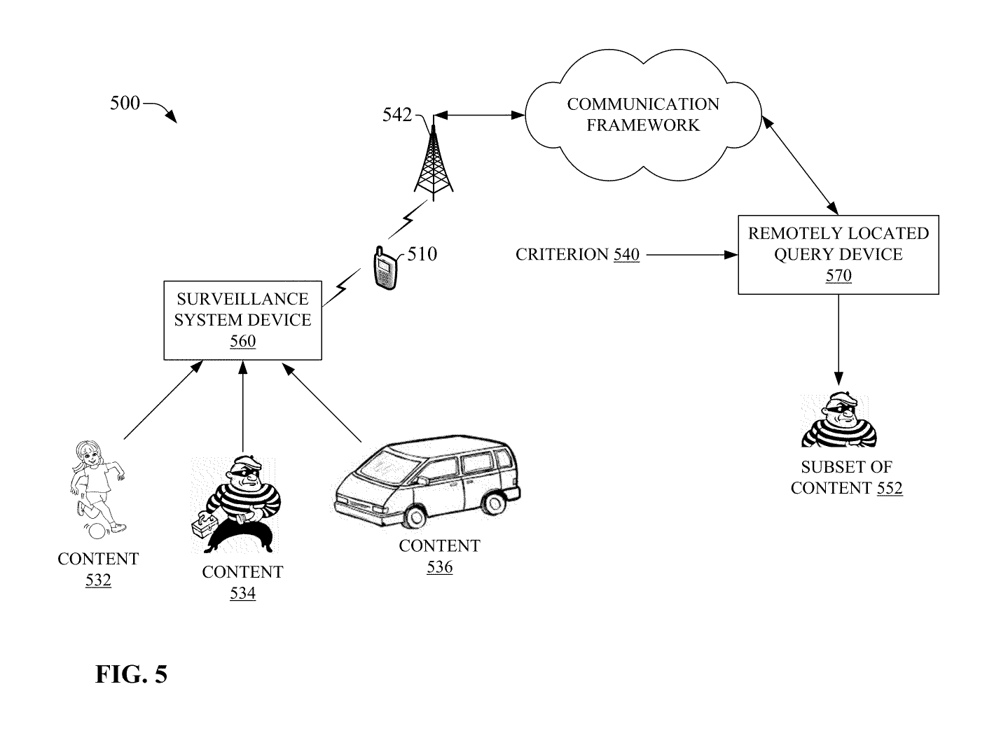

FIG. 5 illustrates exemplary system 500 that employs a mobile device as an intermediary for content analysis between a remote query device and a surveillance system via a wireless carrier network in accordance with aspects of the subject disclosure. System 500 can be a non-limiting example and can comprise mobile device 510. Mobile device 510 can be a smartphone, tablet computer, laptop computer, or any other type of mobile device, but is illustrated as a cellular phone in FIG. 5 for clarity and brevity. In an aspect, mobile device 510 can be a consumer electronic device, e.g., a mobile device intended for consumer use as compared to use by an agency, government, or other mission specific group of users. Mobile device 510 can comprise an analysis component (not illustrated). The analysis component can analyze content to determine an occurrence of a characteristic, property, attribute, or feature of the content. Content can comprise an image, a video frame, a sound or other type of audio content, a smell or other olfactory content, etc. In an aspect, content can further comprise information related to an image, video, audio, etc., such as location information, time, date, temperature, direction, acceleration, color saturation, motion, etc. In an aspect, the analysis component can determine a subset of the content based on the analysis of the content.

Mobile device 510 can receive criterion 540 from remotely located query device 570. Criterion 540 can be received by mobile device 510 through a wired connection or a wireless connection. Where criterion 540 is received by a wireless connection, this connection can comprise cellular signaling, Wi-Fi signaling, Bluetooth-type signaling, etc. In an aspect, mobile device 510 can be coupled to a radio access network (RAN) 542 operated by a wireless network provider such that criterion 540 can be received via RAN 542. As an example, criterion 540 can be received from a NodeB, a femtocell, etc. Criterion 540 can be employed in analysis of content to facilitate identifying and/or determining a subset of relevant content via the analysis component. Further, RAN 542 can be communicatively coupled to remotely located query device 570 via a communications framework, as illustrated.

Mobile device 510 can facilitate access to subset of content 552 via remotely located device 570. Subset of content 552 can comprise relevant content determined from analysis of content, e.g., content 532-536 by an analysis component (not illustrated) of mobile device 510 based on criterion 540. Of note, subset of content 552 can be none, some, or all of content, e.g., content 532-536. As such, mobile device 510 acts as a MDI for analysis of content, e.g., content 532-536, based on criterion 540 and returning subset of content 552 via remotely located query device 570. As such, analysis of content can be offloaded from the remotely located device which can both reduce computation performed by the remotely located device where analysis is performed at mobile device 510 rather than at remotely located query device 570 and can similarly reduce the amount of data that is communicated to remotely located query device 570 because only a subset of content, e.g., content 532-536, is communicated back to the remotely located device.

Mobile device 510 can receive content, e.g., content 532-536, by way of surveillance system device 560 Mobile device 510 can be communicatively coupled to a nearby device, e.g., surveillance system device 560, etc., by way of a wireless local communications component (not illustrated). Content, e.g., content 532-536, can be received at mobile device 510 via surveillance system device 560. Surveillance system device 560 can receive visual content. In an aspect, surveillance system device 560 can further include a content storage component (not illustrated) to store content. Surveillance system device 560 can be, for example, a bank surveillance system that can comprise an image capture component to capture images from an image sensor (not illustrated) and store the images on a hard drive device (content store, not illustrated). As illustrated in FIG. 5, surveillance system device 560 can capture, for example, an image of a girl with a ball 532, a bank robber 534, and a parked minivan 536.

Mobile device 510 can receive content 530, e.g., the image of the girl with the ball 532, the bank robber 534, and the parked minivan 536, via surveillance system device 560 to facilitate analysis of the content based on criterion 540. Mobile device 510 can negotiate access to the content via surveillance system device 560 to facilitate analysis of content 530 (not illustrated). Access can be based on access protocols associated with remotely located query device 570 via a MDI comprising Mobile device 510. This aspect can allow remotely located query device 570 to access content from surveillance system device 560 that would not typically be accessible by Mobile device 510, e.g., banks typically want to selectively limit access to their surveillance content to approved entities. Where criteria, e.g., criterion 540, specifying masked males near the bank at about the time of a recent bank robbery, is received at mobile device 510 from remotely located query device 570 via of RAN 542, mobile device 510 can analyze content received from surveillance system device 560, e.g., the image of the girl with the ball 532, the bank robber 534, and the parked minivan 536, for images having occurrences of the criteria. Based on the analysis, a subset of the content can be determined and made accessible to remotely located query device 570, such that subset of content 552 is received because only content 534 meets the specified criteria, e.g., criterion 540. As such, mobile device 510 illustrates operation as a MDI to reduce data transmitted over communications framework, e.g., only subset of content 552 is returned rather than returning each of the image of the girl with the ball 532, the bank robber 534, and the parked minivan 536 to remotely located query device 570. Further mobile device 510 acting as a MDI can reduce computation at remotely located query device 570 because image analysis is shifted from remotely located query device 570 to mobile device 510. Moreover, because mobile device 510 acts an intermediary, a user of mobile device 510 can be excluded from accessing the sensitive bank surveillance system image content because the subset of the content is returned to remotely located query device 570.

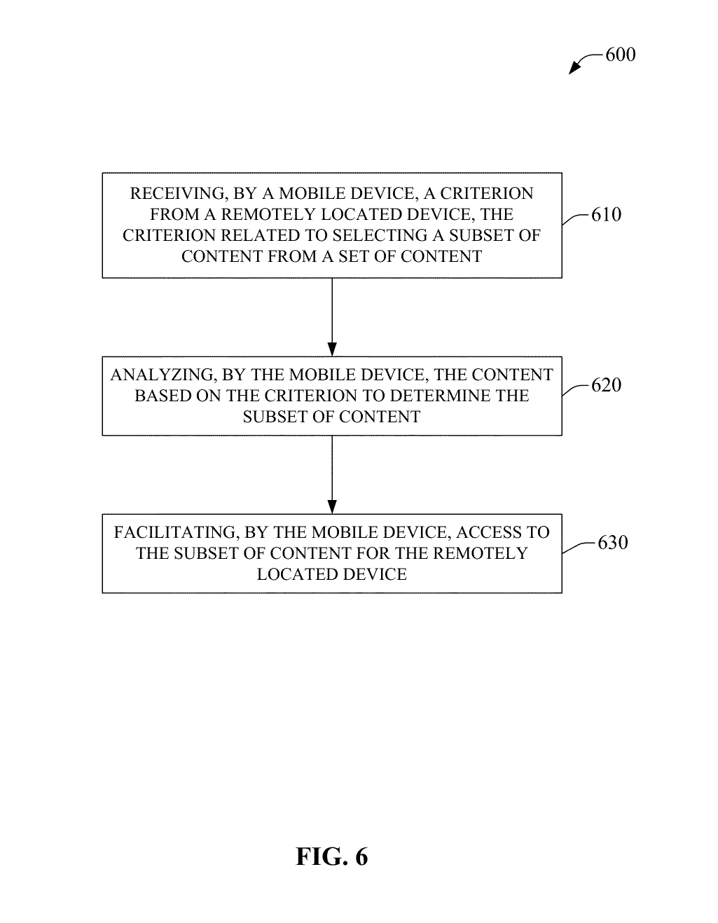

In view of the example system(s) described above, example method(s) that can be implemented in accordance with the disclosed subject matter can be better appreciated with reference to flowcharts in FIG. 6-FIG. 8. For purposes of simplicity of explanation, example methods disclosed herein are presented and described as a series of acts; however, it is to be understood and appreciated that the claimed subject matter is not limited by the order of acts, as some acts may occur in different orders and/or concurrently with other acts from that shown and described herein. For example, one or more example methods disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a described example method in accordance with the subject specification. Further yet, two or more of the disclosed example methods can be implemented in combination with each other, to accomplish one or more aspects herein described. It should be further appreciated that the example methods disclosed throughout the subject specification are capable of being stored on an article of manufacture (e.g., a computer-readable medium) to allow transporting and transferring such methods to computers for execution, and thus implementation, by a processor or for storage in a memory.

FIG. 6 illustrates aspects of method 600 facilitating employing a mobile device as an intermediary for content analysis in accordance with aspects of the subject disclosure. At 610, method 600 can include reviving a criterion by a mobile device. The criterion can be from a remotely located device. The criterion can be related to selecting a subset of content from a set of content. Content can comprise an image, a video frame, a sound or other type of audio content, a smell or other olfactory content, etc. In an aspect, content can further comprise information related to an image, video, audio, etc., such as location information, time, date, temperature, direction, acceleration, color saturation, motion, etc. The mobile device can be a smartphone, tablet computer, laptop computer, or any other type of mobile device. In an aspect, the mobile device can be a consumer electronic device, e.g., a mobile device intended for consumer use as compared to use by an agency, government, or other mission specific group of users.

The mobile device can receive criterion from the remotely located device. The criterion can be received by the mobile device through a wired connection or a wireless connection. Where the criterion is received via a wireless connection, this connection can comprise cellular signaling, Wi-Fi signaling, Bluetooth-type signaling, etc. In an aspect, the mobile device can be coupled to a radio access network (RAN) operated by a wireless network provider such that the criterion can be received via the RAN. As an example, the criterion can be received from a NodeB, a femtocell, etc. The criterion can be employed in analysis of content to facilitate identifying and/or determining a subset of relevant content.

At 620, method 600 can analyze the content by the mobile device. The content can be analyzed based on the criterion to determine the subset of content. Content analysis can determine an occurrence of a characteristic, property, attribute, or feature of the content. As such, analysis of content can determine, for example, a facial feature, a vehicle type, a vehicle make, a vehicle model, a height, a gender, an age, an article of clothing, a clothing accessory, eye color, ethnicity, motion, a flash, a sharp sound/report/bang, a sound of breaking glass, a weather characteristic, a pressure wave front, smoke, mist, etc., occurring in the content.

In an aspect, content can be stored on the mobile device, e.g., stored in a memory of the mobile device as disclosed herein. In a further aspect, content can be received from a device associated with the mobile device, e.g., from a cloud based storage account, a social media account (e.g., Facebook, etc.), from a personal media server or network attached storage device, etc. In another aspect, content can be received from a local device, e.g., from a camera, video recorder, microphone, or other sensor, etc., in the general proximity of the mobile device, for example, from an ATM camera located a near the mobile device, a Bluetooth-type connected headset microphone, a wearable device such as a Google Glass-type device, etc. Still further, in an aspect, content can be received from a content storage device located near the mobile device, for example, from a tethered digital camera, from a wirelessly connected traffic camera, from a store security system storage device, etc. The mobile device can negotiate access to content to facilitate analysis of content. Access can be based on access protocols associated with a remotely located device querying content via a MDI comprising the mobile device. As an example, where a government agency queries an ATM camera content by way of a mobile device belonging to a nurse standing near the ATM, access to the ATM content can be allowed based on a protocol associated with the government agency in contrast to the nurse, who would not typically be allowed access to the ATM content. This aspect can allow remotely located query devices having the right permissions to access content that would not generally be accessible by an owner of a consumer electronic device.

At 630, method 600 can facilitate access to the subset of content for the remotely located device. At this point method 600 can end. Access can be facilitated by the mobile device. The subset of content can comprise relevant content determined from analysis of the content based on the criterion. Of note, the subset of content can be none, some, or all of the content. The mobile device can act as a MDI for analysis of content based on the criterion and returning the subset of the content to the remotely located device. As such, analysis of content can be offloaded from the remotely located device that can reduce computation performed by the remotely located device where analysis is performed at the mobile device rather than at the remotely located device. Further, this can also reduce the amount of data that is communicated to the remotely located device because only a subset of the content, rather than all of the content, can be communicated back to the remotely located device.

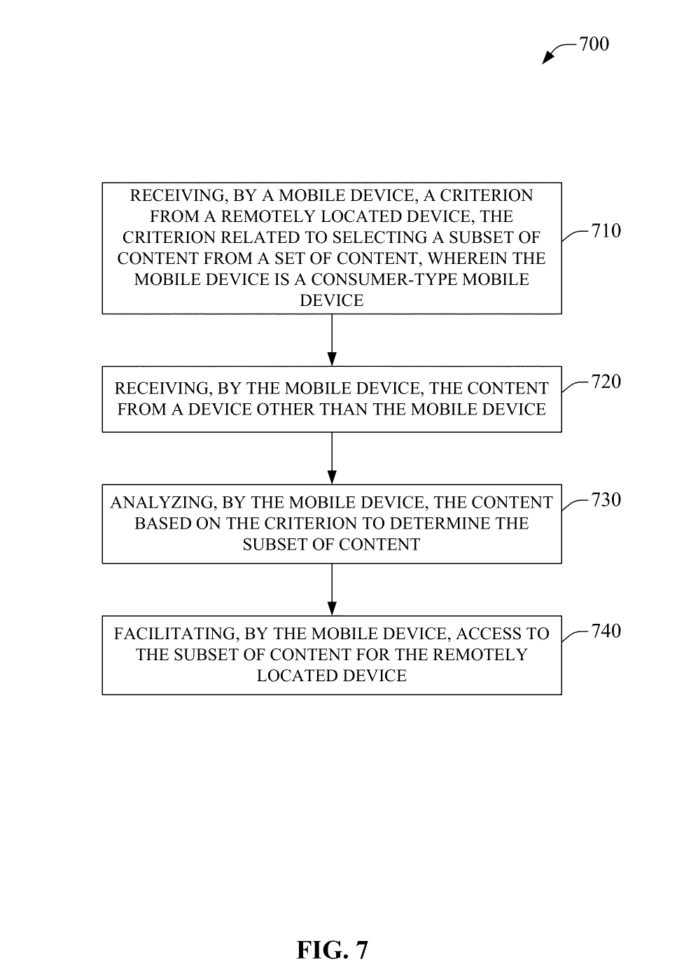

FIG. 7 illustrates a method 700 that facilitates employing a mobile device as an intermediary for content analysis of content from a content device other than the mobile device in accordance with aspects of the subject disclosure. At 710, method 700 can include can include reviving a criterion by a mobile device. The criterion can be from a remotely located device. The mobile device can be a consumer-type mobile device, e.g., a mobile device intended for consumer use as compared to use by an agency, government, or other mission specific group of users. The mobile device can be a smartphone, tablet computer, laptop computer, or any other type of mobile device. The criterion can be related to selecting a subset of content from a set of content. Content can comprise an image, a video frame, a sound or other type of audio content, a smell or other olfactory content, etc. In an aspect, content can further comprise information related to an image, video, audio, etc., such as location information, time, date, temperature, direction, acceleration, color saturation, motion, etc.

The mobile device can receive criterion from the remotely located device. The criterion can be received by the mobile device through a wired connection or a wireless connection. Where the criterion is received via a wireless connection, this connection can comprise cellular signaling, Wi-Fi signaling, Bluetooth-type signaling, etc. In an aspect, the mobile device can be coupled to a radio access network (RAN) operated by a wireless network provider such that the criterion can be received via the RAN. As an example, the criterion can be received from a NodeB, a femtocell, etc. The criterion can be employed in analysis of content to facilitate identifying and/or determining a subset of relevant content.

At 720, method 700 can receive, by the mobile device, the content from a device other than the mobile device. Content can be received from a local device, e.g., from a camera, video recorder, microphone, or other sensor, etc., in the general proximity of the mobile device, for example, from an ATM camera located a near the mobile device, a Bluetooth-type connected headset microphone, a wearable device such as a Google Glass-type device, etc. In an aspect, content can be received from a content storage device located near the mobile device, for example, from a tethered digital camera, from a wirelessly connected traffic camera, from a store security system storage device, etc. The mobile device can negotiate access to content to facilitate analysis of content. Access can be based on access protocols associated with a remotely located device querying content via a MDI comprising the mobile device. This aspect can allow remotely located query devices having the right permissions to access content that would not generally be accessible by an owner of a consumer-type mobile device.

At 730, method 700 can, by the mobile device, analyze the content. The content can be analyzed based on the criterion to determine the subset of content. Content analysis can determine an occurrence of a characteristic, property, attribute, or feature of the content.

At 740, method 700 can facilitate, by the mobile device, access to the subset of content for the remotely located device. At this point method 700 can end. The subset of content can comprise relevant content determined from analysis of the content based on the criterion. Of note, the subset of content can be none, some, or all of the content. The mobile device can act as a MDI for analysis of content based on the criterion and returning the subset of the content to the remotely located device. Analysis of content can be reduced at the remotely located device by performing the analysis at the mobile device rather than at the remotely located device. This can further reduce the amount of data communicated to the remotely located device where a subset of the content is communicated back.

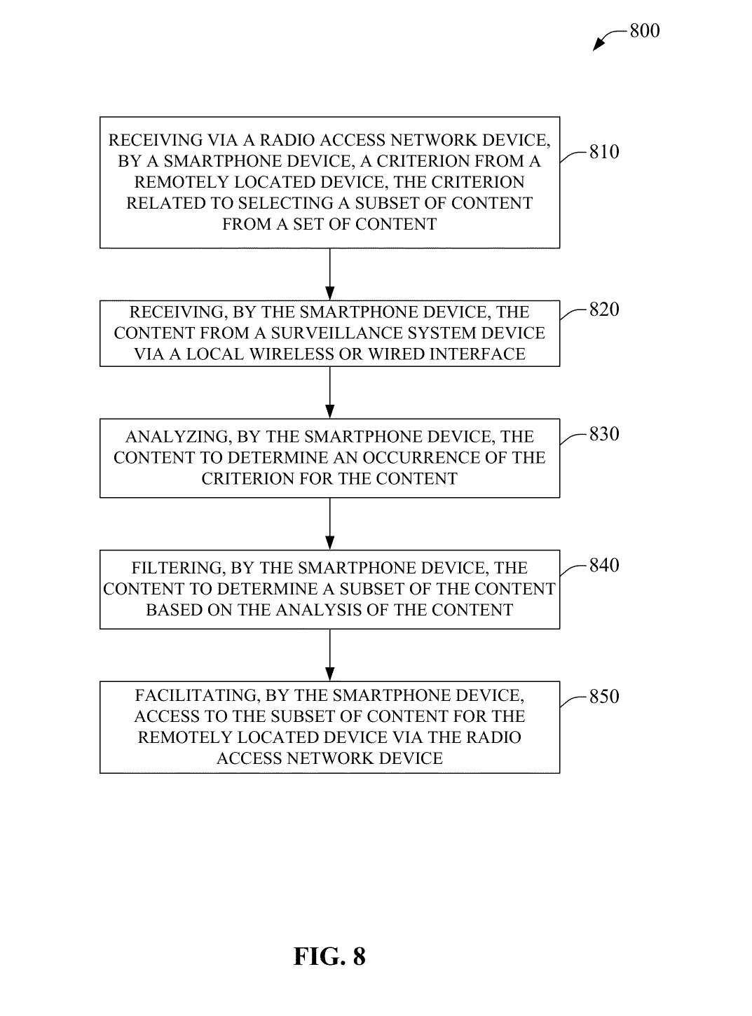

FIG. 8 illustrates a method 800 that facilitates employing a smartphone device as an intermediary for content analysis between a remote query device and a surveillance system device via a radio access network in accordance with aspects of the subject disclosure. At 810, method 800 can include reviving via a radio access network (RAN) a criterion by a smartphone device. The criterion can be from a remotely located device. The criterion can be related to selecting a subset of content from a set of content. Content can comprise an image, a video frame, audio content, etc. In an aspect, content can further comprise information related to an image, video, audio, etc., such as location information, time, date, temperature, direction, acceleration, color saturation, motion, etc. In an aspect, the smartphone device can be a consumer electronic device, e.g., a smartphone device intended for consumer use as compared to use by an agency, government, or other mission specific group of users.

The smartphone device can receive criterion from the remotely located device. The criterion can be received by the smartphone device through a wired connection or a wireless connection. Where the criterion is received via a wireless connection, this connection can comprise cellular signaling, Wi-Fi signaling, Bluetooth-type signaling, etc. In an aspect, the smartphone device can be coupled to a RAN operated by a wireless network provider such that the criterion can be received via the RAN. As an example, the criterion can be received from a NodeB, a femtocell, etc. The criterion can be employed in analysis of content to facilitate identifying and/or determining a subset of relevant content.

At 820, method 800 can receive, by the smartphone device, the content from a surveillance system device via a local wireless or wired interface. Content can be received from a local device, e.g., from a camera, video recorder, microphone, or other sensor, etc., in the general proximity of the smartphone device, for example, from an surveillance system camera located near the smartphone device, etc. In an aspect, content can be received from a content storage device of the surveillance system device, for example, from a store security system storage device, etc. The smartphone device can negotiate access to content to facilitate analysis of content. Access can be based on access protocols associated with a remotely located device querying content via a MDI comprising the smartphone device. This aspect can allow remotely located query devices having the right permissions to access content that would not generally be accessible by an owner of a consumer-type smartphone device.

At 830, method 800 can analyze the content by the smartphone device. The content can be analyzed to determine an occurrence of the criterion in the content. Similarly, the analysis can determine an occurrence of a property, attribute, or feature of the content.

At 840, method 800 can filter the content by the smartphone device. The filtering of the content can determine a subset of the content based on the analysis of the content at 830. The subset of content can comprise relevant content determined from analysis of the content based on the criterion. Of note, the subset of content can be none, some, or all of the content.

At 850, method 800 can facilitate access to the subset of content for the remotely located device via the RAN. At this point method 800 can end. Access can be facilitated by the smartphone device. The smartphone device can act as a MDI for analysis of content based on the criterion and returning the subset of the content to the remotely located device via the radio access network.

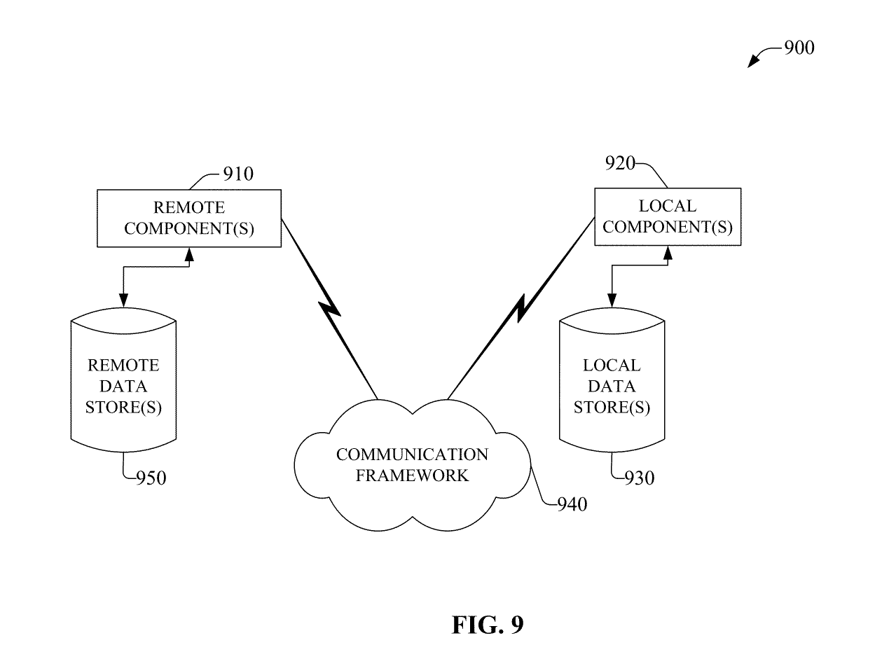

FIG. 9 is a schematic block diagram of a computing environment 900 with which the disclosed subject matter can interact. The system 900 includes one or more remote component(s) 910. The remote component(s) 910 can be hardware and/or software (e.g., threads, processes, computing devices). In some embodiments, remote component(s) 910 can include servers, governmental agency computers, etc. As an example, remote component(s) 910 can be a police agency computer, a paid parking company computer, etc.

The system 900 also includes one or more local component(s) 920. The local component(s) 920 can be hardware and/or software (e.g., threads, processes, computing devices). In some embodiments, local component(s) 920 can include mobile device 110, 210, 310, 410, 510, etc., content storage device 260, surveillance system device 360, 460, etc. As an example, local component(s) 920 can be a content storage device of an ATM device. As another example, local component(s) 920 can be a MDI comprising a smartphone.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. As an example, services information, focus state information, device environment information, proximity determination information, location information, etc., can be communicated over a packet-switched or circuit-switched channels between a parking enforcement query device, e.g., remote component 910, and a smartphone device, e.g., a local component 920, over an air interface, such as on a packet-switched or circuit-switched downlink channel. The system 900 includes a communication framework 940 that can be employed to facilitate communications between the remote component(s) 910 and the local component(s) 920, and can include an air interface, e.g., Uu interface of a UMTS network. Remote component(s) 910 can be operably connected to one or more remote data store(s) 950, such as a criteria set store, etc., that can be employed to store information, such as sets of criteria, on the remote component(s) 910 side of communication framework 940. Similarly, local component(s) 920 can be operably connected to one or more local data store(s) 930, such as content storage device 260, etc., that can be employed to store information, such as content for analysis, on the to the local component(s) 920 side of communication framework 940.

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules include routines, programs, components, data structures, etc. that performs particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or nonvolatile memory, or can include both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read only memory, programmable read only memory, electrically programmable read only memory, electrically erasable read only memory, or flash memory. Volatile memory can include random access memory, which acts as external cache memory. By way of illustration and not limitation, random access memory is available in many forms such as synchronous random access memory, dynamic random access memory, synchronous dynamic random access memory, double data rate synchronous dynamic random access memory, enhanced synchronous dynamic random access memory, Synchlink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, including single-processor or multiprocessor computer systems, mini-computing devices, mainframe computers, as well as personal computers, hand-held computing devices (e.g., personal digital assistant, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012, which can be, for example, part of mobile device 110, consumer electronic mobile device 210, smartphone device 310, 410, surveillance system device 360, 460, etc., or employing method 600, 700, or 800, etc., includes a processing unit 1014, a system memory 1016, and a system bus 1018. System bus 1018 couples system components including, but not limited to, system memory 1016 to processing unit 1014. For example, a security monitoring system can comprise computer 1012 and system 100 to provide content to mobile device 110 for analysis based on criterion 140. Processing unit 1014 can be any of various available processors. Dual microprocessors and other multiprocessor architectures also can be employed as processing unit 1014.

System bus 1018 can be any of several types of bus structure(s) including a memory bus or a memory controller, a peripheral bus or an external bus, and/or a local bus using any variety of available bus architectures including, but not limited to, industrial standard architecture, micro-channel architecture, extended industrial standard architecture, intelligent drive electronics, video electronics standards association local bus, peripheral component interconnect, card bus, universal serial bus, advanced graphics port, personal computer memory card international association bus, Firewire (Institute of Electrical and Electronics Engineers 1194), and small computer systems interface.

System memory 1016 can include volatile memory 1020 and nonvolatile memory 1022. A basic input/output system, containing routines to transfer information between elements within computer 1012, such as during start-up, can be stored in nonvolatile memory 1022. By way of illustration, and not limitation, nonvolatile memory 1022 can include read only memory, programmable read only memory, electrically programmable read only memory, electrically erasable read only memory, or flash memory. Volatile memory 1020 includes read only memory, which acts as external cache memory. By way of illustration and not limitation, read only memory is available in many forms such as synchronous random access memory, dynamic read only memory, synchronous dynamic read only memory, double data rate synchronous dynamic read only memory, enhanced synchronous dynamic read only memory, Synchlink dynamic read only memory, Rambus direct read only memory, direct Rambus dynamic read only memory, and Rambus dynamic read only memory.

Computer 1012 can also include removable/non-removable, volatile/non-volatile computer storage media. FIG. 10 illustrates, for example, disk storage 1024. Disk storage 1024 includes, but is not limited to, devices like a magnetic disk drive, floppy disk drive, tape drive, flash memory card, or memory stick. In addition, disk storage 1024 can include storage media separately or in combination with other storage media including, but not limited to, an optical disk drive such as a compact disk read only memory device, compact disk recordable drive, compact disk rewritable drive or a digital versatile disk read only memory. To facilitate connection of the disk storage devices 1024 to system bus 1018, a removable or non-removable interface is typically used, such as interface 1026.

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, read only memory, programmable read only memory, electrically programmable read only memory, electrically erasable read only memory, flash memory or other memory technology, compact disk read only memory, digital versatile disk or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can include non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software includes an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. As an example, a user interface can be embodied in a touch sensitive display panel allowing a user to interact with computer 1012. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 include, for example, a serial port, a parallel port, a game port, a universal serial bus, an infrared port, a Bluetooth port, an IP port, or a logical port associated with a wireless service, etc. Output device(s) 1040 use some of the same type of ports as input device(s) 1036.

Thus, for example, a universal serial busport can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 include, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, cloud service, a workstation, a microprocessor based appliance, a peer device, or other common network node and the like, and typically includes many or all of the elements described relative to computer 1012.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local area networks and wide area networks. Local area network technologies include fiber distributed data interface, copper distributed data interface, Ethernet, Token Ring and the like. Wide area network technologies include, but are not limited to, point-to-point links, circuit-switching networks like integrated services digital networks and variations thereon, packet switching networks, and digital subscriber lines. As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can include, for example, internal and external technologies such as modems, including regular telephone grade modems, cable modems and digital subscriber line modems, integrated services digital network adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment (UE),” “mobile station,” “mobile,” “subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point,” “base station,” “Node B,” “evolved Node B,” “home Node B,” “home access point,” and the like, are utilized interchangeably in the subject application, and refer to a wireless network component or appliance that serves and receives data, control, voice, video, sound, gaming, or substantially any data-stream or signaling-stream to and from a set of subscriber stations or provider enabled devices. Data and signaling streams can include packetized or frame-based flows.

Additionally, the terms “core-network”, “core”, “core carrier network”, “carrier-side”, or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. UEs do not normally connect directly to the core networks of a large service provider but can be routed to the core by way of a switch or radio access network. Authentication can refer to determinations regarding whether the user requesting a service from the telecom network is authorized to do so within this network or not. Call control and switching can refer determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g. call transfer) or implicitly (e.g., call waiting). It is to be noted that service “execution” may or may not be a core network functionality as third party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include broadcast technologies (e.g., sub-Hertz, extremely low frequency, very low frequency, low frequency, medium frequency, high frequency, very high frequency, ultra-high frequency, super-high frequency, terahertz broadcasts, etc.); Ethernet; X.25; powerline-type networking, e.g., Powerline audio video Ethernet, etc; femto-cell technology; Wi-Fi; worldwide interoperability for microwave access; enhanced general packet radio service; third generation partnership project, long term evolution; third generation partnership project universal mobile telecommunications system; third generation partnership project 2, ultra mobile broadband; high speed packet access; high speed downlink packet access; high speed uplink packet access; enhanced data rates for global system for mobile communication evolution radio access network; universal mobile telecommunications system terrestrial radio access network; or long term evolution advanced.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A mobile device, comprising:
a memory to store instructions; and
a processor coupled to the memory, that facilitates execution of the instructions to perform operations, comprising:
receiving a criterion from a remotely located device, wherein the criterion is associated with determining an occurrence of an entity in content;
receiving the content;
analyzing the content based on the criterion;
determining a subset of the content based on the analyzing; and
facilitating access to the subset of the content for the remotely located device.

2. The mobile device of claim 1, wherein the mobile device is a mobile device primarily intended for use by a consumer in a non-professional capacity.

3. The mobile device of claim 1, wherein the mobile device comprises telephonic features and Internet access via a wireless connection to a wireless network.

4. The mobile device of claim 1, wherein the content is received from another device other than the mobile device or the remotely located device.

5. The mobile device of claim 4, wherein the other device is a content storage device.

6. The mobile device of claim 4, wherein the other device is a surveillance system device.

7. The mobile device of claim 4, wherein the content is received wirelessly from the other device.

8. The mobile device of claim 1, wherein the access to the subset of the content is unavailable for the mobile device.

9. The mobile device of claim 1, wherein the operations further comprise receiving an input, and performing the analyzing in response to the input indicating permission to perform the analyzing.

10. A method, comprising:
receiving, by a mobile device comprising a processor, a criterion from a remotely located device, wherein the criterion is related to selecting a subset of content from a set of content based on determining an instance of an entity in the content;
receiving, by the mobile device, the set of content;
analyzing, by the mobile device, the set of content based on the criterion;
determining, by the mobile device, the subset of content from the set of content based on the analyzing; and
facilitating, by the mobile device, access to the subset of content for the remotely located device.

11. The method of claim 10, wherein the receiving comprises receiving the criterion by a mobile device primarily intended for use in a capacity other than for analyzing the set of content.

12. The method of claim 10, wherein the receiving comprises receiving the criterion by a mobile device that facilitates telephonic communication and Internet access via a wireless connection to a wireless network.

13. The method of claim 10, wherein the receiving the set of content comprises receiving at least some of the content from another device other than the mobile device or the remotely located device.

14. The method of claim 10, wherein the receiving the set of content comprises receiving at least some of the content from a surveillance system device other than the mobile device or the remotely located device.

15. The method of claim 10, wherein the accessing the content is unavailable for the mobile device.

16. The method of claim 10, further comprising receiving, by the mobile device, an input representing a permission to perform the analyzing, wherein the analyzing is performed in response to the receiving the input representing the permission.

17. A computer-readable storage medium having instructions stored thereon that, in response to execution, cause a mobile device comprising a processor to perform operations, the operations comprising:
receiving a set of criteria from a remotely located device, wherein the set of criteria relate to identifying an occurrence of a feature in a set of content;
receiving the set of content from a device other than the mobile device or the remotely located device;
analyzing the set of content based on the set of criteria;
determining a subset of content from the set of content based on the analyzing; and
facilitating access to the subset of content for the remotely located device.

18. The computer-readable storage medium of claim 17, wherein the mobile device is a mobile phone.

19. The computer-readable storage medium of claim 17, wherein the accessing the subset of content is unavailable for the mobile device.

20. The computer-readable storage medium of claim 17, wherein the analyzing is performed in response to receiving an input comprising information representing a permission to perform the analyzing.
